(19) United States
(12) Patent Application Publication
(10) Pub. No.: US 2017/0170972 A1
(43) Pub. Date: Jun. 15, 2017

(54) UNMANNED AERIAL VEHICLE OPERATOR IDENTITY AUTHENTICATION SYSTEM

(71) Applicant: NUVOTON TECHNOLOGY CORPORATION, HSINCHU CITY (TW)

(72) Inventors: CHI-FENG WU, Hsinchu Science Park (TW); TZU-LAN SHEN, Taoyuan City (TW)

(21) Appl. No.: 15/246,935

(22) Filed: Aug. 25, 2016

(30) Foreign Application Priority Data
Dec. 15, 2015 (TW) 104220106

(51) Int. Cl. H04L 9/32; B64C 39/02; H04L 9/08

(52) U.S. Cl. CPC H04L 9/3263; H04L 9/0894; B64C 39/024; H04L 2209/84; B64C 2201/146

(57) ABSTRACT

An unmanned aerial vehicle operator identity authentication system is provided, including a flight control module and a license certificate module connected with each other. The flight control module includes a first encryption and decryption unit for generating a random number code, and a first storage unit for storing a license register table. The license certificate module includes a second storage unit for storing a license certificate identifier, and a second encryption and decryption unit for encrypting the received random number code and the license certificate identifier, and transmitting the encrypted data to the first encryption and decryption unit. After decryption, if the first encryption and decryption unit determines that the decrypted random number code is the same as the original random number code, and the decrypted license certificate identifier exists in the license register table, the operator identity authentication is completed and the UAV can be actuated.

### CROSS-REFERENCE TO RELATED APPLICATION

This application claims the benefit of Taiwan Patent Application No. 104220106, filed on Dec. 15, 2015, the disclosure of which is incorporated herein in its entirety by reference, in the Taiwan Intellectual Property Office.

### BACKGROUND OF THE INVENTION

1. Field of the Invention

The present disclosure relates to an operator identity authentication system, and more particularly to an identity authentication system in which a license certificate module can be connected to a flight control module of an unmanned aerial vehicle (UAV) to authenticate whether an operator owns a valid license to operate the UAV.

2. Description of the Related Art

In recent year, with progress of the electronic technology, an unmanned aerial vehicle (hereafter refer to as a UAV) is applied more widely, for example, the UAV can function as an unmanned military fighter, or an aerial vehicle for scientific observation, investigation, or search and rescue assistance. For example, the UAV for aerial photography, which is equipped with at least one camera device for capturing image or recording video during flight, is a well-known UAV for the general public. Compared with the conventional aerial vehicle, the UAV can be operated by a remote control manner without a driver staying therein, so the UAV has advantages of light weight, low manufacturing cost and high flexibility.

However, the flight speed and altitude of the UAV are significantly higher than that of the vehicle moving on the ground, so the UAB operator is required to have better operation and control skill. The operator controlling military UAV must be well trained, but there is no similar operation training or specification for the operator who controls the commercial UAV, as a result, accident that the UAV collides the building or falls because of careless operation sometimes occurs. Apparently, specifications for the UAV operation and the UAV operator both must be strengthened.

It is suggested that the UAV operator is not allowed to operate the UAV in practice until the UAV operator is well trained to have sufficient capacity in operating the UAV. Therefore, what is need is to enable the UAV to authenticate whether the operator has a valid operating license.

### SUMMARY OF THE INVENTION

An objective of the present disclosure is to provide an unmanned aerial vehicle operator identity authentication system to effectively prevent the operator not having valid license from operating the UAV, so as to reduce the occurrence of possible accident.

In order to achieve the objective, the present disclosure is to provide an unmanned aerial vehicle operator identity authentication system comprising a flight control module and a license certificate module. The flight control module is configured to control the UAV, and the license certificate module is connected to the flight control module through a connection interface. The flight control module includes a first encryption and decryption unit and a first storage unit. The first encryption and decryption unit is configured to generate a random number code, and the first storage unit is configured to store at least one key, the random number code and a license register table which records a plurality of valid certificate identifiers. The license certificate module includes a second storage unit and a second encryption and decryption unit. The second storage unit is configured to store a license certificate identifier representing an operator's identity, and the second encryption and decryption unit is configured to receive the random number code, use the received random number code to encrypt the license certificate identifier, and transmit the encrypted license certificate identifier to the first encryption and decryption unit. The first encryption and decryption unit uses the key to perform decryption, and the unmanned aerial vehicle is activated only when the first encryption and decryption unit confirms that the decrypted random number code is the same as the random number code generated by the first encryption and decryption unit originally, and the license certificate identifier is matched with one of the valid certificate identifiers.

Preferably, the at least one key includes a master public key and a master private key, the first encryption and decryption unit transmits the master public key and the random number code to the second encryption and decryption unit, and the second encryption and decryption unit uses the master public key to encrypt the received random number code and the license certificate identifier, and then transmits encrypted data to the first encryption and decryption unit, and the encryption and decryption unit uses the master private key to decrypt the encrypted data to obtain the random number code and the license certificate identifier.

Preferably, the at least one key includes a master public key and a master private key, the first encryption and decryption unit uses the master public key to encrypt the random number code, and transmit the encrypted random number code to the second encryption and decryption unit.

Preferably, the second storage unit is configured to store the master public key and a first private key, the second encryption and decryption unit uses the master public key to encrypt the license certificate identifier, and uses the first private key to encrypt the random number code, and then transmits the encrypted license certificate identifier and the encrypted random number code to the first encryption and decryption unit. The first encryption and decryption unit uses the master private key to decrypt the encrypted license certificate identifier, and then from the first storage unit searches a second private key corresponding to the first private key, and uses the second private key to decrypt the encrypted random number code.

Preferably, the connection interface includes a USB interface, a serial peripheral interface (SPI) or an inter-integrated circuit bus (I²C) interface.

Preferably, the UAV further includes a global position system (GPS) module configured to detect a location area code.

Preferably, the first storage unit further stores at least one area code indicative of the area where the UAV is allowed to fly legally, and the flight control module activates the UAV only when the location area code detected by the global position system is matched with the at least one area code.

Preferably, the license certificate identifier includes a licensing area code, and the flight control module activates the UAV only when the location area code is matched with the licensing area code.

Preferably, the operator identity authentication system further includes a license certificate server configured to record at least one valid operator and the license certificate identifier thereof.

Preferably, the first storage unit is linked with the license certificate server to update the plurality of valid certificate identifiers recorded in the license register table.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 is a schematic view of an unmanned aerial vehicle operator identity authentication system of the present disclosure.

FIG. 2 is a block diagram of an embodiment of the unmanned aerial vehicle operator identity authentication system of the present disclosure.

FIG. 3 is a block diagram of another embodiment of the unmanned aerial vehicle operator identity authentication system of the present disclosure.

FIG. 4 is a block diagram of an alternative embodiment of the unmanned aerial vehicle operator identity authentication system of the present disclosure.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

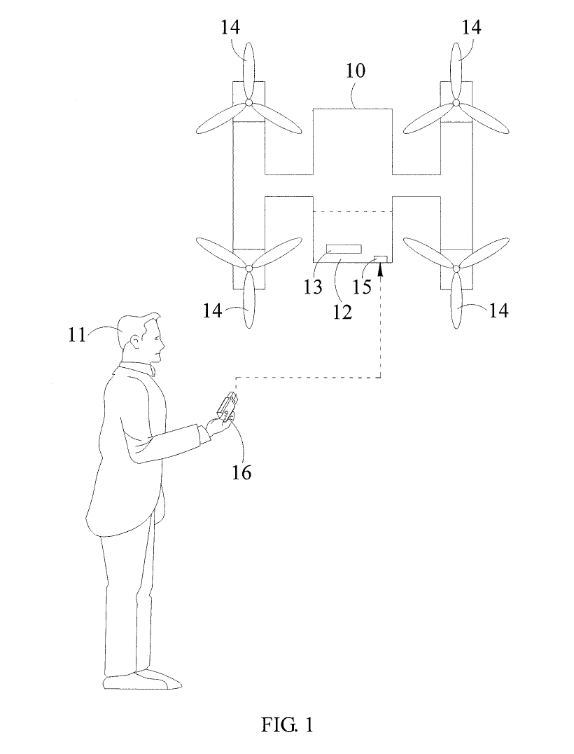

Please refer to FIG. 1 which is a schematic view of an unmanned aerial vehicle operator identity authentication system of the present invention. As shown in FIG. 1, the operator identity authentication system includes a UAV 10 which is to be activated by an operator 11. The unmanned aerial vehicle 10 includes a flight control module 12 and a power supply module 13. The flight control module 12 functions as a controller and at least includes a processor, an antenna and a wireless transmission device, and the power supply module 13 (such as a rechargeable battery) supplies power to the flight control module 12. The flight control module 12 is electrically connected to a driving device and other devices for taking off and landing, such as multi-axis propellers 14 and at least one motor. The flight control module 12 is configured to transform the wirelessly-received instruction into an operating instruction for controlling the UAV 10 to take off, land or fly. It should be noted that the UAV 10 is not limited to the UAV using multi-axis propellers, and any UAV which can be operated by a remote control manner and without a driver stays therein is embraced by the scope of the present disclosure. The type of the UAV is not a key feature, so its detailed description is omitted, and the UAV using multi-axis propellers is just taken as an example for illustration.

While operating a conventional UAV 10, the operator 11 just turns on the power supply module 13 to activate the UAV 10, and then operates a remote controller to control the UAV 10 to take off, land or fly. However, the conventional way of operating the UAV does not include a step of authenticating the operation capacity of the operator 11, that is, in prior art any one can activate and operate the UAV 10 to fly. In the present embodiment, the flight control module 12 of the operator identity authentication system of the present disclosure is provided with a connection interface to connect with a license certificate module 16 for authenticating the license of the operator 11, and the operator 11 cannot activate the UAV 10 until the identity of the operator 11 is authenticated through the license certificate module 16. Preferably, the license certificate module 16 can be a storage device having a USB interface, and by inserting the USB interface into a USB insertion slot of the connection interface, the license certificate module 16 can be connected with the flight control module 12 for performing identity authentication; however, the present disclosure is not limited thereto. Alternatively, the connection interface 15 can be other peripheral interface, such as a serial peripheral interface (SPI) or Inter-Integrated Circuit (I²C) interface, and the license certificate module 16 has a corresponding transmission line for connection with the connection interface 15. The operator identity authentication system of the present disclosure will be described in detail with reference with the embodiment below.

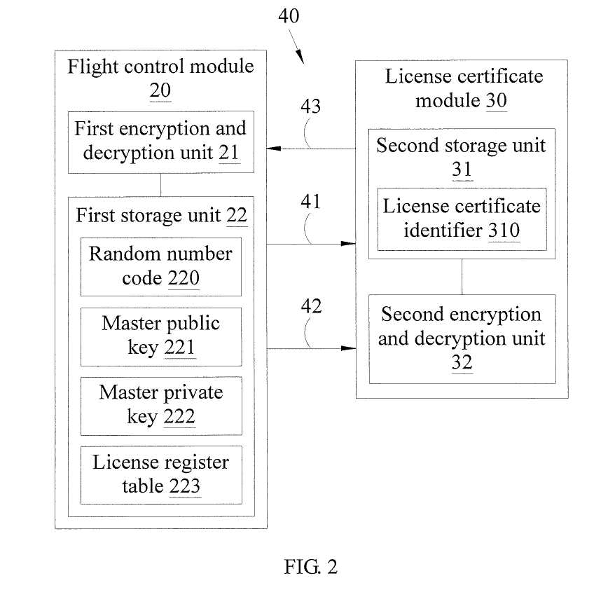

Please refer to FIG. 2 which is a schematic view of an embodiment of the unmanned aerial vehicle operator identity authentication system of the present invention. In the embodiment, the operator identity authentication system includes a flight control module 20 and a license certificate module 30 disposed in the aerial vehicle. The flight control module 20 can be a controller of the unmanned aerial vehicle, and the license certificate module 30 can be a USB storage device which can be connected to the flight control module 20 through a USB connection interface 40. The flight control module 20 includes a first encryption and decryption unit 21 and a first storage unit 22. Preferably, the first encryption and decryption unit 21 can be a chip for performing encryption and decryption, such as a trusted platform module (TPM) chip. The first storage unit 22 can be a flash memory or one of various forms of memory cards. The first encryption and decryption unit 21 is configured to generate a random number code 220 and store the random number code 220 in the first storage unit 22. Different authentication codes are generated at different authentication time points based on the random number code, so as to improve the safety of the operator identity authentication system of the present disclosure. In addition, the first storage unit 22 further stores keys for encryption and decryption and at least one valid certificate identifier. In present embodiment, the keys includes a master public key 221 and a master private key 222, and all valid certificate identifiers form a license register table 223 which provides related information for subsequent encryption, decryption and identity comparison.

Please refer to FIG. 2. The license certificate module 30 is electrically connected to the flight control module 20 through the connection interface 40, and includes a second storage unit 31 and a second encryption and decryption unit 32. Preferably, the second storage unit 31 can be flash memory inside the USB storage device, or memory media accessible through other connection interface. Similar to the first encryption and decryption unit 21, the second encryption and decryption unit 32 can be a chip for encryption and decryption, such as the TPM chip. The second storage unit 31 stores the operator's license certificate identifier 310. The license certificate identifier 310 is a license certificate number issued by a training institution or a certification authority after the operator passes the training for driving the UAV in the training institution. The license certificate identifier 310 can be burnt in the USB storage device, so as to prevent replication.

In present embodiment, after the flight control module 20 and the license certificate module 30 are connected with each other, the flight control module 20 transmits the master public key 221 (in a transmission step 41) and a random number code 220 (in a transmission step 42) to the license certificate module 30. Upon receipt of the master public key 221 and the random number code 220, the second encryption and decryption unit 32 uses the master public key 221 to encrypt on the received random number code 220 and the license certificate identifier 310, and then transmits the encrypted data back to the flight control module 20 (in a transmission step 43). Upon receipt of the encrypted data, the flight control module 20 decrypts the encrypted data and then checks whether the license certificate identifier 310 is valid, so as to determine whether the operator owning the license certificate module 30 is valid to activate the UAV. The way of identity authentication will be described in detail below. The first encryption and decryption unit 21 uses the master private key 222 to decrypt the encrypted data, to obtain the decrypted random number code and the license certificate identifier 310. Next, the first encryption and decryption unit 21 checks whether the decrypted random number code is the same as the random number code 220 which is originally generated by the first encryption and decryption unit 21 and then transmitted to the license certificate module 30. If the decrypted random number code is not the same as the original random number code 220, the authentication fails, the process is stopped and the UAV cannot be activated. If the decrypted random number code is the same as the original random number code 220, the first encryption and decryption unit 21 further checks whether the license certificate identifier 310 is matched with one of the valid certificate identifiers in the license register table 223; if no, the first encryption and decryption unit 21 determines the current operator to be invalid, and the UAV cannot be activated. If the license certificate identifier 310 exists in the license register table 223, the operator identity authentication is completed and the UAV can be activated for subsequent control.

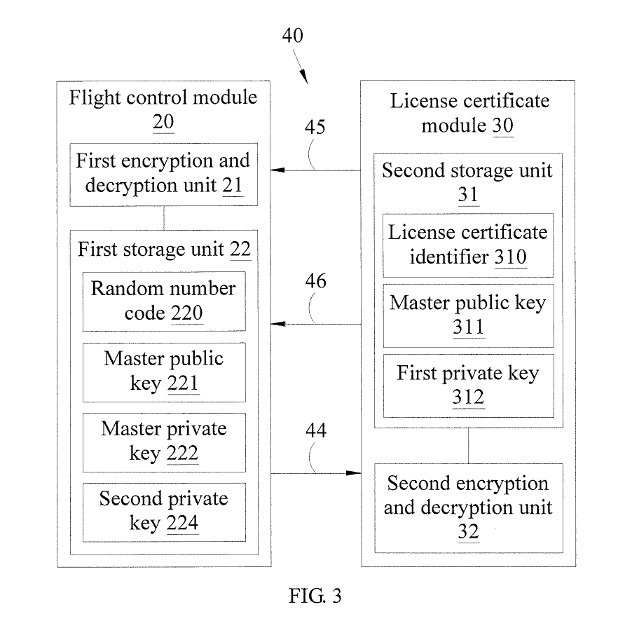

Please refer to FIG. 3 which is a schematic view of other embodiment of the unmanned aerial vehicle operator identity authentication system of the present invention. In this embodiment, the operator identity authentication system includes the flight control module 20 installed in the UAV and the license certificate module 30 of the operator. In FIGS. 2 and 3, the same reference numbers are used to the same or like parts, so the detailed descriptions are omitted. The difference between this present embodiment and previous embodiment is that the random number code 220 originally generated by the first encryption and decryption unit 21 is encrypted according to the master public key 221 first and the encrypted random number code 220 is then transmitted to the license certificate module 30 (in a transmission step 44). As a result, even if the master public key 221 is intercepted during transmission, the person with bad intention fails to obtain the real content of the random number code 220 and crack the subsequent identity authentication procedure. Moreover, upon receipt of the encrypted random number code 220, the license certificate module 30 uses stored key (such as the master public key 311) to decrypt the received random number code 220, and then uses the master public key 311 to encrypt the license certificate identifier 310 and uses a first private key 312 to encrypt the random number code 220 and, next, transmits the encrypted license certificate identifier 310 (in a transmission step 45) and the encrypted random number code 220 (in a transmission step 46) to the flight control module 20. Two different keys are used in above encryptions, so the difficulty of cracking the system of the present disclosure and pretending as a valid operator is increased. In addition, the first encryption and decryption unit 21 uses the master private key 222 stored in the first storage unit 22 to decrypt the encrypted license certificate identifier 310, searches the second private key 224 corresponding to the first private key 312 in the first storage unit, and then uses the second private key 224 to decrypt the encrypted random number code. The first storage unit 22 can store a private key database including multiple second private keys 224 for different operators using different first private keys 312. After decryption, the first encryption and decryption unit 21 checks the decrypted random number code is the same as the random number code 220 first, and then checks whether the decrypted license certificate identifier 310 exists in the license register table, if the two checking results are yes, the authentication for the operator's identity is completed.

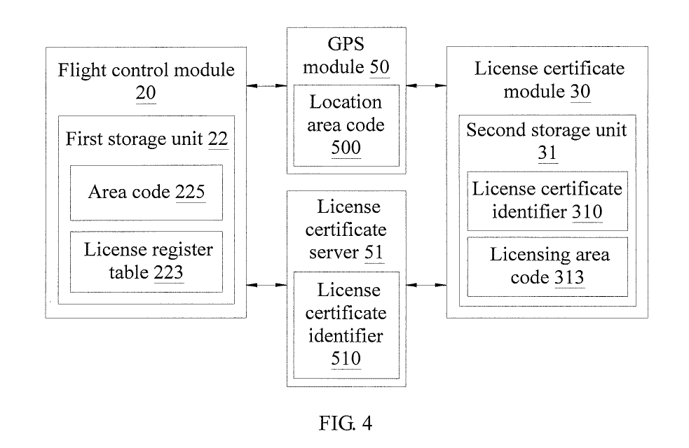

Please refer to FIG. 4 which is a schematic view of alternative embodiment of the unmanned aerial vehicle operator identity authentication system of the present invention. In this embodiment, the UAV can further include a global position system (GPS) module 50 configured to detect a location area code 500 indicative of a nation, city or area where the UAV is located. At least one area code 225 indicative of the area where the UAV can be operated legally is also stored in the first storage unit 22 of the first storage unit 22 in advance. By means of pre-storing the area code 225 in the UAV, the UAV can be limited to only fly in the valid area for sake of aviation safety. When the detected location area code 500 is not matched with the at least one area code 225 stored in the first storage unit 22, the flight control module 20 fails to activate the UAV. Similarly, the GPS module 50 of the present embodiment can also be applied to identity authentication for the operator. The second storage unit 31 of the license certificate module 30 owned by the operator can store the license certificate identifier 310 and a licensing area code 313 both. When the licensing area code 313 is matched with the location area code 500 detected by the GPS module 50, the flight control module 20 can complete the operator identity authentication and then activate the UAV. In contrast, when the licensing area code 313 is not matched with the detected location area code 500, the flight control module 20 fails to activate the UAV. Since regulations of areas may have different restrictions for UAV flight and the license certificate identifier 310 for single area is not allowed to be used in different areas, above-mentioned authentication scheme can prevent the operator, who just has the UAV driving license for single area, operates the UAV in other areas.

Please refer to FIG. 4. The unmanned aerial vehicle operator identity authentication system can further include a license certificate server 51 disposed at a competent authority which issues the operator license. After the operator passes the training or test to obtain the qualification for driving UAV, the operator's license certificate identifier 510 is created by the license certificate server 51 and written in the license certificate module 30, and the valid operator can own the license certificate module 30. The UAV manufacturer can obtain data of the valid UAV operators from the license certificate server 51, and store the license certificate identifiers associated with the valid UAV operators in the first storage unit 22 of the flight control module 20, so as to form the license register table 223. Alternatively, the UAV can be periodically linked with the license certificate server 51 to update the data of valid UAV operators and their license certificate identifiers, so as to make sure that all license certificate identifiers of the license register table 223 stored in first storage unit 22 represent the valid operators.

In some embodiments, the unmanned aerial vehicle operator identity authentication system of the present disclosure has at least one of advantages described below.

(1) The unmanned aerial vehicle operator identity authentication system is able to authenticate whether the operator identity is valid, so that only the operator having the valid license certificate is able to activate and control the UAV, thereby effectively reducing the occurrence of accident and improving the safety of the UAV.

(2) The unmanned aerial vehicle operator identity authentication system of the present disclosure is able to use the key to encrypt and decrypt the data for transmission, so as to prevent the valid operator's license certificate identifier from being stolen by person with bad intention, and further reduce the risk that the license certificate is embezzled.

(3) In the unmanned aerial vehicle operator identity authentication system of the present disclosure, the flight control module and the license certificate module can be connected with each other through USB or other appropriate transmission interface, so as to improve the efficiency and convenience of identity authentication without using extra special recognizing device.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An unmanned aerial vehicle operator identity authentication system, comprising:
a flight control module configured to control the UAV and comprising:
a first encryption and decryption unit configured to generate a random number code; and
a first storage unit configured to store at least one key, the random number code and a license register table which records a plurality of valid certificate identifiers; and
a license certificate module electrically connected to the flight control module through a connection interface, and comprising:
a second storage unit configured to store a license certificate identifier representing an operator's identity; and
a second encryption and decryption unit configured to receive the random number code, encrypt the random number code and the license certificate identifier, and transmit the encrypted random number code and license certificate identifier to the first encryption and decryption unit;
wherein the first encryption and decryption unit uses the at least one key to decrypt the encrypted random number code and license certificate identifier, and the unmanned aerial vehicle is activated only when the first encryption and decryption unit confirms that the decrypted random number code is the same as the random number code originally generated by the first encryption and decryption unit and the license certificate identifier is matched with one of the valid certificate identifiers.

2. The unmanned aerial vehicle operator identity authentication system according to claim 1, wherein the at least one key comprises a master public key and a master private key, the first encryption and decryption unit transmits the master public key and the random number code to the second encryption and decryption unit, and the second encryption and decryption unit uses the master public key to encrypt the random number code and the license certificate identifier, and then transmit the encrypted random number code and the license certificate identifier to the first encryption and decryption unit, and the encryption and decryption unit uses the master private key to decrypt the encrypted random number code and the license certificate identifier, so as to obtain the random number code and the license certificate identifier.

3. The unmanned aerial vehicle operator identity authentication system according to claim 1, wherein the at least one key comprises a master public key and a master private key, the first encryption and decryption unit uses the master public key to encrypt the random number code, and transmits the encrypted random number code to the second encryption and decryption unit.

4. The unmanned aerial vehicle operator identity authentication system according to claim 3, wherein the second storage unit is configured to store the master public key and a first private key, the second encryption and decryption unit uses the master public key to encrypt the license certificate identifier, and uses the first private key to encrypt the random number code, and then transmits the encrypted license certificate identifier and the encrypted random number code to the first encryption and decryption unit, and the first encryption and decryption unit uses the master private key to decrypt the encrypted license certificate identifier, and from the first storage unit searches a second private key corresponding to the first private key, and uses the second private key to decrypt the encrypted random number code.

5. The unmanned aerial vehicle operator identity authentication system according to claim 1, wherein the connection interface comprises a USB interface, a serial peripheral interface or an inter-integrated circuit bus interface.

6. The unmanned aerial vehicle operator identity authentication system according to claim 1, further comprising a global position system module configured to detect a location area code.

7. The unmanned aerial vehicle operator identity authentication system according to claim 6, wherein the first storage unit is configured to store at least one area code indicative of an area where the UAV is allowed to fly legally, and the flight control module activates the UAV only when the location area code detected by the global position system is matched with the at least one area code.

8. The unmanned aerial vehicle operator identity authentication system according to claim 7, wherein the license certificate identifier comprises a licensing area code, and the flight control module activates the UAV only when the location area code is matched with the licensing area code.

9. The unmanned aerial vehicle operator identity authentication system according to claim 1, further comprising:
a license certificate server configured to record at least one valid operator and the license certificate identifier thereof.

10. The unmanned aerial vehicle operator identity authentication system according to claim 9, wherein the first storage unit is linked with the license certificate server to update the plurality of valid certificate identifiers recorded in the license register table.
